(19) United States
(12) Patent Application Publication
(10) Pub. No.: US 2019/0303095 A1
(43) Pub. Date: Oct. 3, 2019

(54) VOICE ACTIVATION SYSTEM OF A VEHICLE

(71) Applicant: Ford Global Technologies, LLC, Dearborn, MI (US)

(72) Inventors: Pallav Sohoni, Farmington Hills, MI (US); Kevin James Rhodes, Dearborn, MI (US); Erik J. Christen, Royal Oak, MI (US)

(73) Assignee: Ford Global Technologies, LLC

(21) Appl. No.: 15/936,610

(22) Filed: Mar. 27, 2018

(51) Int. Cl. G06F 3/16; G10L 15/22; G01S 5/30; G06K 9/00; B60K 35/00

(52) U.S. Cl. CPC G06F 3/167; G10L 15/22; G01S 5/30; B60K 2350/1044; B60K 35/00; G10L 2015/223; G10L 2015/227; G06K 9/00369

(57) ABSTRACT

A voice activation system of a vehicle is provided herein. Microphones are disposed within a vehicle cabin and are configured to detect a voice command spoken by a vehicle occupant. A controller is configured to determine a location of the vehicle occupant based on a time in which the voice command is received by each microphone and generate a control signal for operating a feature specific to the determined location of the vehicle occupant and responsive to the voice command.

### FIELD OF THE INVENTION

The present invention generally relates to voice activation systems of a vehicle, and more particularly, to voice activation systems capable of detecting a location of an occupant within the vehicle.

### BACKGROUND OF THE INVENTION

Many vehicles have localized features specific to particular seating areas. Such features may include localized air conditioning or heating, heated or cooled seats, and localized sound management, to name a few. In order to activate such features, a vehicle occupant may be required to use buttons, knobs, or other electromechanical user-input devices. This is often inconvenient for a vehicle occupant who is not in close proximity to such devices. Accordingly, there is a need for a more convenient way to activate a feature specific to a location of a vehicle occupant. The present disclosure is intended to satisfy this need.

### SUMMARY OF THE INVENTION

According to a first aspect of the present invention, a voice activation system of a vehicle is provided. Microphones are disposed within a vehicle cabin and are configured to detect a voice command spoken by a vehicle occupant. A controller is configured to determine a location of the vehicle occupant based on a time in which the voice command is received by each microphone and generate a control signal for operating a feature specific to the determined location of the vehicle occupant and responsive to the voice command.

Embodiments of the first aspect of the invention can include any one or a combination of the following features:
a number of the microphones are located in a front passenger compartment of the vehicle and another number of the microphones are located in a rear passenger compartment of the vehicle;
each microphone is coupled to one of an A pillar and a B pillar of the vehicle;
the controller is further configured to determine the location of the vehicle occupant based on a signal amplitude of the voice command received by each microphone;
the controller is further configured to determine the location of the vehicle occupant based on a vehicle cabin temperature;
the controller is further configured to determine the location of the vehicle occupant based on input received from an occupant sensor system;
the input indicates which seat is occupied by the vehicle occupant; and
the feature includes one of localized air conditioning or heating, localized sound management, heated or cooled seats, localized ambient light management, localized window or door lock management, and localized seat settings including massage function or seat orientation.

According to a second aspect of the present invention, a voice activation system of a vehicle is provided. Microphones are disposed within a vehicle cabin and are configured to detect a voice command spoken by a vehicle occupant. A controller is configured to determine a location of the vehicle occupant based on a time in which the voice command is received by each microphone and at least one of a signal amplitude of the voice command received by each microphone, input received from a cabin temperature sensor, and input received from an occupant sensor system. The controller is further configured to generate a control signal for operating a feature specific to the determined location of the vehicle occupant and responsive to the voice command.

Embodiments of the second aspect of the invention can include any one or a combination of the following features:
a number of the microphones are located in a front passenger compartment of the vehicle and another number of the microphones are located in a rear passenger compartment of the vehicle;
each microphone is coupled to one of an A pillar and a B pillar of the vehicle;
the signal amplitude corresponds to a peak signal amplitude;
the input received from the occupant sensor system indicates which seat is occupied by the vehicle occupant; and
the feature includes one of localized air conditioning or heating, localized sound management, heated or cooled seats, localized ambient light management, localized window or door lock management, and localized seat settings including massage function or seat orientation.

According to a third aspect of the present invention, a method of controlling a localized feature of a vehicle is provided. The method includes the steps of using microphones to detect a voice command spoken by a vehicle occupant, providing a controller configured to determine a location of the vehicle occupant based on a time in which the voice command is received by each microphone, and generating a control signal for operating a feature specific to the determined location of the vehicle occupant and response to the voice command.

Embodiments of the third aspect of the invention can include any one or a combination of the following features:
the step of using the controller to validate the determined location based on one or more additional considerations;
the one or more additional considerations includes an assessment of a signal amplitude of the voice command received by each microphone;
the one or more additional considerations comprises a vehicle cabin temperature;
the one or more additional considerations comprises input received from an occupant sensor system; and
the input indicates which seat is occupied by the vehicle occupant.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a plan view of a vehicle equipped with a voice activation system;

FIG. 2 is a block diagram of the voice activation system;

FIG. 3 illustrates an arrival time and a signal amplitude of a voice command received by a number of microphones; and

FIG. 4 is a flow diagram of a method of controlling a localized vehicle feature based on voice activation.

### DETAILED DESCRIPTION OF THE PREFERRED EMBODIMENTS

As required, detailed embodiments of the present invention are disclosed herein.

However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

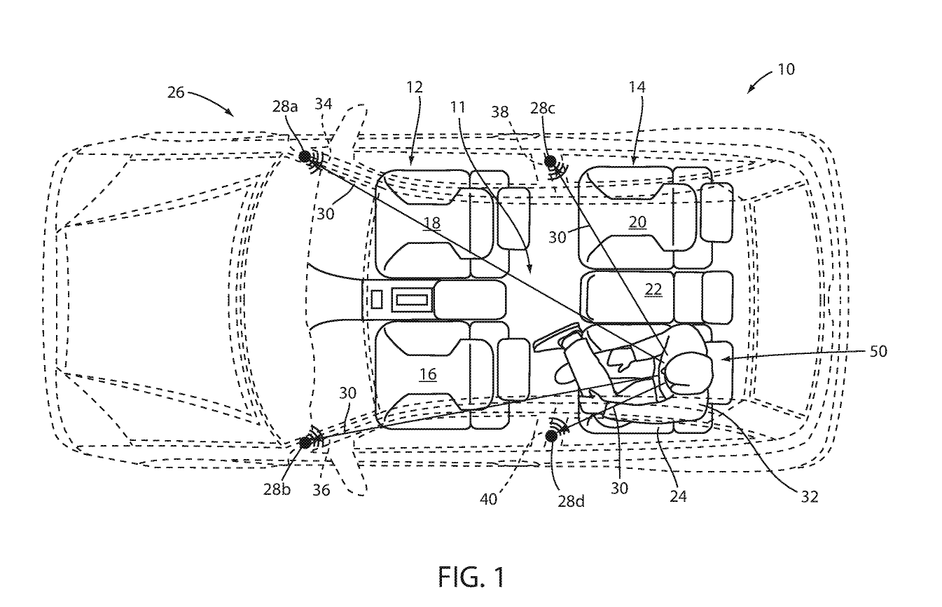

Referring to FIG. 1, a plan view of a vehicle 10 is shown. For exemplary purposes, the vehicle 10 is a sports utility vehicle (SUV) having a vehicle cabin 11 defined by a front passenger compartment 12 and a rear passenger compartment 14. A first row of seats including a driver seat 16 and a front passenger seat 18 is located in the front passenger compartment 12 and a second row of seats including a rear passenger-side seat 20, a rear middle seat 22, and a rear driver-side seat 24 is located in the rear passenger compartment 14. While the vehicle 10 is shown having two rows of seats, it will be understood that the innovations described herein are also applicable to vehicles having more seating.

As shown in FIG. 1, the vehicle 10 includes a voice activation system 26 having microphones 28a-28d disposed within the vehicle cabin 11 and configured to detect a voice command 30 spoken by a vehicle occupant 32. For purposes of illustration and understanding, microphones 28a and 28b are located in the front passenger compartment 12 and microphones 28c and 28d are located in the rear passenger compartment 14. More specifically, microphone 28a is coupled to a passenger-side A pillar 34 and microphone 28b is coupled to a driver-side A pillar 36. Microphone 28c is coupled to a passenger-side B pillar 38 and microphone 28d is coupled to a driver-side B pillar 40. It will be understood, however, that the number and the locations of the microphones 28a-28d are exemplary in nature.

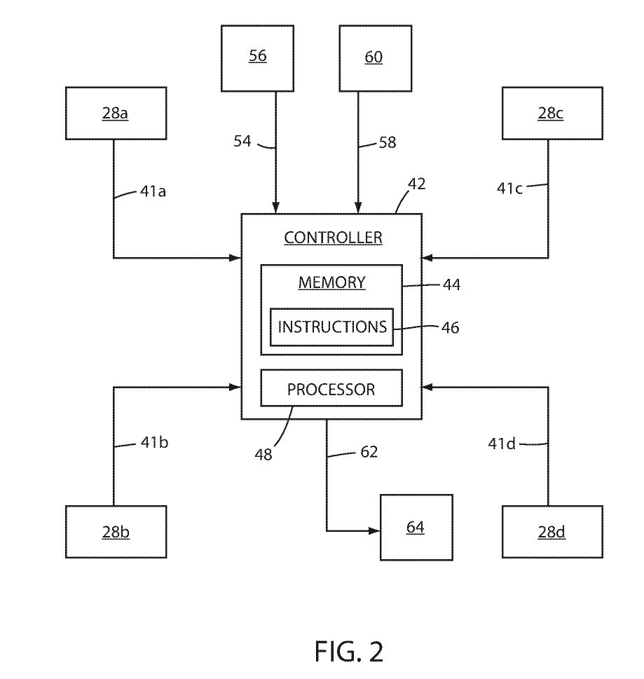

Referring to FIGS. 1 and 2, the microphones 28a-28d detect the voice command 30 spoken by the vehicle occupant 32. Upon detecting the voice command 30, each microphone 28a-28d generates input 41a-41d provided to a controller 42 in communication therewith. The controller 42 includes a memory 44 having instructions 46 stored thereon that are executed by a processor 48. The instructions 46 are carried out to enable the controller 42 to determine a location 50 of the vehicle occupant 32 based on a time in which the voice command 30 is received by each microphone 28a-28d. For example, FIG. 2 illustrates the variation in which the voice command 30 is received by each microphone 28a-28d. As shown, by virtue of the proximity of the vehicle occupant 32 to each microphone 28a-28d, the voice command 30 is first received by microphone 28d followed in order by microphones 28c, 28b, and 28a. Based on this information, the controller 42 is able to determine the location 50 of the vehicle occupant 32 using sound triangulation or any other suitable acoustic location technique.

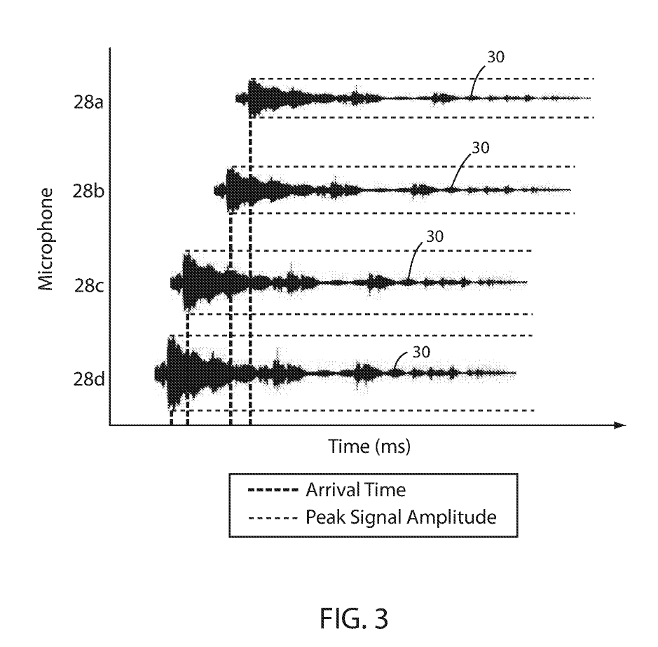

Additionally, the controller 42 may consider a signal amplitude of the voice command 30 received by each microphone 28a-28d. Since the sound intensity of the voice command 30 will decrease over increasing distance from a given microphone 28a-28d, the controller 42 may further determine the location 50 of the vehicle occupant 32 based on a peak signal amplitude of the voice command 30 received by each microphone 28a-28d. For example, FIG. 3 illustrates the variation in peak signal amplitude 52a-52d for each of the microphones 28a-28d, respectively. As shown, by virtue of the travel distance of the voice command 32 to each microphone 28a-28d, microphone 28d exhibits the greatest peak signal amplitude 52d followed in order by microphones 28c, 28b, and 28a.

Since the speed of sound varies by temperature, it is contemplated that the controller 42 may also consider temperature input 54 received from a cabin temperature sensor 56 in determining the location 50 of the vehicle occupant 32. Additionally, the controller 42 may consider input 58 received from an occupant sensor system 60 indicating that the vehicle occupant 32 is seated in the rear driver-side seat 24. Accordingly, it will be understood that the controller 42 may determine the location 50 of the vehicle occupant 32 based on the time in which the voice command 30 is received by each microphone 28a-28d, but may additionally consider peak signal amplitude, vehicle cabin temperature, occupant seating information, or a combination thereof.

In response to determining the location 50 of the vehicle occupant 32, the controller 42 generates a control signal 62 for operating a feature 64 specific to the determined location 50 of the vehicle occupant 32 and responsive to the voice command 30. For example, the feature 64 may include, but is not limited to, localized air conditioning or heating, localized sound management, heated or cooled seats, localized ambient light management, localized window or door lock management, and localized seat settings including massage function or seat orientation. Thus, if the voice command 30 is spoken as “turn heated seat on,” the control signal 62 would activate the heated seat functionality of the rear driver-side seat 24. Accordingly, the controller 30 is configured to not only determine the location 50 of the vehicle occupant 32, but also process the voice command 30 and identify a request associated therewith. In processing the voice command 30, the controller 42 may utilize any known speech recognition technique.

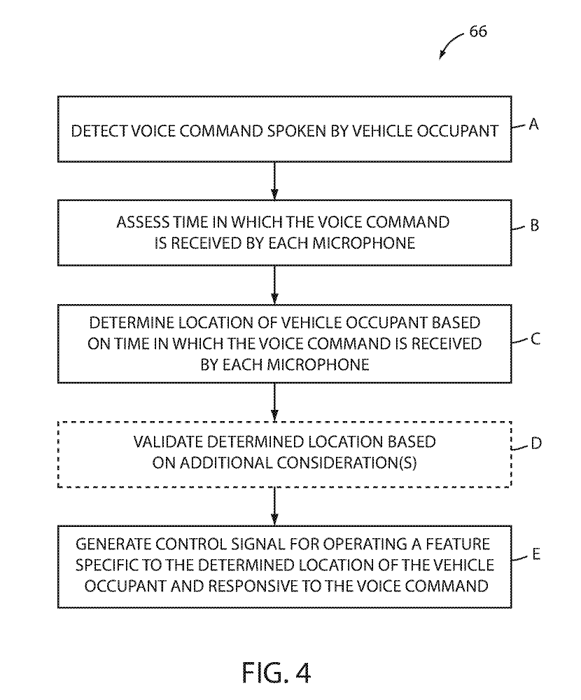

Referring to FIG. 4, a method 66 of controlling a localized vehicle feature based on voice activation is shown. The method 66 is exemplarily described with further reference to the system 26 described herein and may be embodied as instructions 46. At step A, a voice command spoken by a vehicle occupant is detected by the microphones 28a-28d. At step B, a time in which the voice command is received by each microphone 28a-28d is assessed. At step C, a location of the vehicle occupant is determined based on the time in which the voice command is received by each microphone 28a-28d. As described herein, the location may be determined using sound triangulation or other acoustic location techniques. Optionally at step D, the determined location of the vehicle occupant may be validated based on additional consideration(s) including a peak signal amplitude associated with the voice command received by each microphone, a vehicle cabin temperature indicated by the cabin temperature sensor 56, input provided by the occupant sensor system 60, or a combination thereof. At step E, a control signal is generated for operating a feature specific to the determined location of the vehicle occupant and responsive to the voice command. While the steps of the method 66 are generally shown and described in linear fashion, it will be understood that it is not necessary to implement the steps in a step-wise manner. That is, some steps may be performed concurrently and/or the order of some steps may be performed differently without changing the end result.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connector or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes, or steps within described processes, may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further, it is to be understood that such concepts are intended to be covered by the following claims, unless these claims, by their language, expressly state otherwise. Further, the claims as set forth below, are incorporated into and constitute part of this Detailed Description.

What is claimed is:

1. A voice activation system of a vehicle, comprising:
microphones disposed within a vehicle cabin and configured to detect a voice command spoken by a vehicle occupant; and
a controller configured to determine a location of the vehicle occupant based on a time in which the voice command is received by each microphone and generate a control signal for operating a feature specific to the determined location of the vehicle occupant and responsive to the voice command.

2. The voice activation system of claim 1, wherein a number of the microphones are located in a front passenger compartment of the vehicle and another number of the microphones are located in a rear passenger compartment of the vehicle.

3. The voice activation system of claim 1, wherein each microphone is coupled to one of an A pillar and a B pillar of the vehicle.

4. The voice activation system of claim 1, wherein the controller is further configured to determine the location of the vehicle occupant based on a signal amplitude of the voice command received by each microphone.

5. The voice activation system of claim 1, wherein the controller is further configured to determine the location of the vehicle occupant based on a vehicle cabin temperature.

6. The voice activation system of claim 1, wherein the controller is further configured to determine the location of the vehicle occupant based on input received from an occupant sensor system.

7. The voice activation system of claim 6, wherein the input indicates which seat is occupied by the vehicle occupant.

8. The voice activation system of claim 1, wherein the feature comprises one of localized air conditioning or heating, localized sound management, heated or cooled seats, localized ambient light management, localized window or door lock management, and localized seat settings including massage function or seat orientation.

9. A voice activation system of a vehicle, comprising:
microphones disposed within a vehicle cabin and configured to detect a voice command spoken by a vehicle occupant; and
a controller configured to determine a location of the vehicle occupant based on a time in which the voice command is received by each microphone and at least one of a signal amplitude of the voice command received by each microphone, input received from a cabin temperature sensor, and input received from an occupant sensor system, the controller further configured to generate a control signal for operating a feature specific to the determined location of the vehicle occupant and responsive to the voice command.

10. The voice activation system of claim 9, wherein a number of the microphones are located in a front passenger compartment of the vehicle and another number of the microphones are located in a rear passenger compartment of the vehicle.

11. The voice activation system of claim 9, wherein each microphone is coupled to one of an A pillar and a B pillar of the vehicle.

12. The voice activation system of claim 9, wherein the signal amplitude corresponds to a peak signal amplitude.

13. The voice activation system of claim 9, wherein the input received from the occupant sensor system indicates which seat is occupied by the vehicle occupant.

14. The voice activation system of claim 9, wherein the feature comprises one of localized air conditioning or heating, localized sound management, heated or cooled seats, localized ambient light management, localized window or door lock management, and localized seat settings including massage function or seat orientation.

15. A method of controlling a localized feature of a vehicle, comprising the steps of:
using microphones to detect a voice command spoken by a vehicle occupant;
providing a controller configured to determine a location of the vehicle occupant based on a time in which the voice command is received by each microphone; and
generating a control signal for operating a feature specific to the determined location of the vehicle occupant and response to the voice command.

16. The method of claim 15, further comprising the step of using the controller to validate the determined location based on one or more additional considerations.

17. The method of claim 16, wherein the one or more additional considerations comprises an assessment of a signal amplitude of the voice command received by each microphone.

18. The method of claim 16, wherein the one or more additional considerations comprises a vehicle cabin temperature.

19. The method of claim 16, wherein the one or more additional considerations comprises input received from an occupant sensor system.

20. The method of claim 19, wherein the input indicates which seat is occupied by the vehicle occupant.
